(19) United States
(12) Patent Application Publication
(10) Pub. No.: US 2020/0035058 A1
(43) Pub. Date: Jan. 30, 2020

(54) FARE BOX

(71) Applicant: LECIP HOLDINGS CORPORATION, Motosu-Shi (JP)

(72) Inventors: Kenji KIMOTO, Motosu-Shi (JP); Yoshihiro NISHIZAWA, Motosu-Shi (JP); Takeshi MATSUNO, Motosu-Shi (JP); Jun ISHIDA, Motosu-Shi (JP)

(21) Appl. No.: 16/152,851

(22) Filed: Oct. 5, 2018

(30) Foreign Application Priority Data
Oct. 6, 2017 (JP) 2017-196137

(51) Int. Cl. G07D 11/40; G07D 9/00; G07D 11/60; G07D 11/22

(52) U.S. Cl. CPC G07D 11/40; G07D 9/00; G07D 2207/00; G07D 11/22; G07D 2211/00; G07D 11/60

(57) ABSTRACT

Provided is a fare box where the entire structure of the fare box can be simplified even when an operation system for setting an operation of receiving and collecting money is provided to the fare box. A touch-panel-type operating part which is operated at the time of changing an operation of receiving and collecting money is mounted on a back surface of a lid portion of a fare box. The touch-panel-type operating part is operated by a driver, for example, and is preferably a resistance-film-type. Setting which can be made by operating the touch-panel-type operating part includes: a fare change of fares; counting of a student certificate; inputting of a defect, a wireless communication between communication equipment in a vehicle (a Wi-Fi rooter, for example) and the fare box, intercommunication with an information reading part and the like.

### BACKGROUND OF THE INVENTION

### (1) Field of the Invention

The present invention relates to a fare box for receiving and collecting fares.

### (2) Description of Related Art

Conventionally, a public transportation such as a bus or a streetcar is provided with a fare box for receiving and collecting fares such as coins and bills which passengers pay (see JP 2012-164299 A or the like). An operation panel which is operated at the time of changing setting of the fare box is mounted on the fare box described in JP 2012-164299 A. This operation panel is mounted on a fare box body as a part separate from the fare box, for example, and the operation panel is connected to a connector mounted on a wall surface of the fare box by way of a cable.

### SUMMARY OF THE INVENTION

However, when functions of the fare box are increased, there arises a necessity of adding operation panels along with the increase of functions of the fare box. In this case, it is necessary to mount a plurality of operation panels on the fare box or a dashboard or the like on a vehicle side. In this case, there arises a drawback that the operation panels occupy a space around the fare box.

It is an object of the present invention to provide a fare box which is configured to possess the simplified entire configuration even when an operation system for changing an operation of receiving and collecting money is provided to the fare box.

A fare box which can overcome the above-mentioned drawback is configured such that the fare box receives and collects money put in the fare box as a fare, and a touch-panel-type operating part which is operated at the time of setting operations of receiving and collecting the money is integrally formed with the fare box.

With such a configuration, the touch-panel-type operating part is integrally formed with the fare box as an operation system for changing operations of receiving and collecting the money. Accordingly, even when the operation system for changing operations of receiving and collecting the money is provided to the fare box, the entire structure of the fare box can be simplified.

According to the present invention, even when the operation system for setting operations of receiving and collecting the money is provided to the fare box, the entire structure of the fare box can be simplified.

### BRIEF DESCRIPTION OF THE DRAWINGS

FIG. 1 is a perspective view of a fare box according to one embodiment of the present invention as viewed from a front side;

FIG. 2 is a perspective view of the fare box as viewed from a back side;

FIG. 3 is a perspective view of the fare box in a state where a lid portion is opened;

FIG. 4 is a perspective view of a coin identification module;

FIG. 5 is a perspective view of a bill identification module;

FIG. 6A is a perspective view of a coin path switching mechanism before the mechanism is operated;

FIG. 6B is a perspective view of the coin path switching mechanism after the mechanism is operated;

FIG. 7A is a cross-sectional view of the coin identification module when a normal path is effective;

FIG. 7B is a cross-sectional view of the coin identification module when a bypass path is effective;

FIG. 8A is an operational view of a bill path shutter mechanism when a door portion is in a closed state;

FIG. 8B is an operational view of the bill path shutter mechanism when the door portion is in an open state;

FIG. 9 is a perspective view showing the external appearance of a bill chute;

FIG. 10 is an exploded perspective view of a split assembly mechanism;

FIG. 11 is a cross-sectional view of a safe when the safe is mounted on the fare box with a safe lid in an open state; and

FIG. 12 is a cross-sectional view of the safe when the safe is removed from the fare box with the safe lid in a closed state.

### DETAILED DESCRIPTION OF PREFERRED EMBODIMENTS

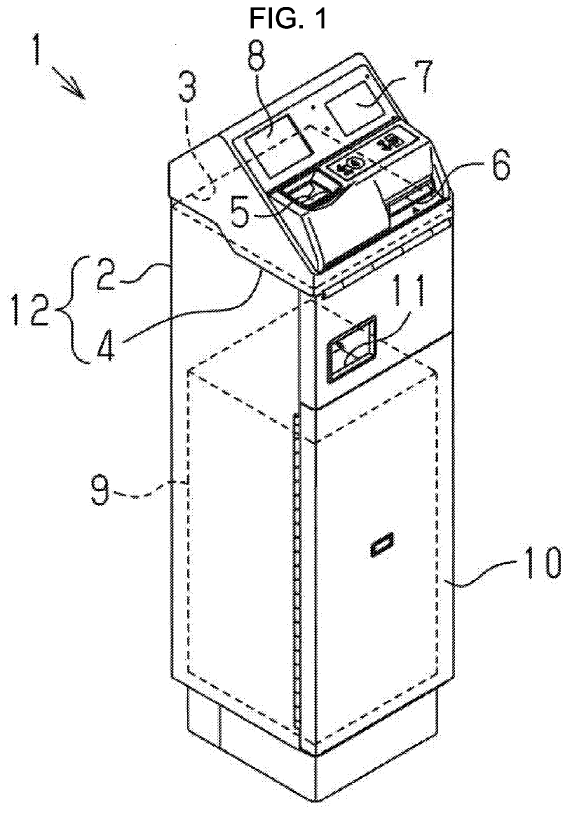

Hereinafter, one embodiment of the fare box is described with reference to FIGS. 1 to 12. As shown in FIG. 1, the fare box 1 in which money (coins and bills) is put as a fare includes: a fare box body 2; and a lid portion 4 which opens or closes an opening portion 3 of the fare box body 2. On a front surface of the lid portion 4, a coin receiving port 5 which receives coins, a bill receiving port 6 which receives bills; an information reading part 7 capable of reading various information by wireless in the fare box 1; and a display part 8 which displays various information relating to the fare. It is preferable that the information reading part 7 be of a type which reads IC or bar codes, for example. A design panel (not shown in the drawing) may be mounted on portions of the information reading part 7 and the display part 8 of the lid portion 4.

An open/close door 10 is mounted on a front surface of the fare box 1. The open/close door 10 is opened or closed at the time of taking out or installing a safe 9 which stores coins and bills put into the fare box 1. A coin return port 11 through which coins in the fare box 1 are discharged to the outside is mounted on the front surface of the fare box body 2 above the open/close door 10.

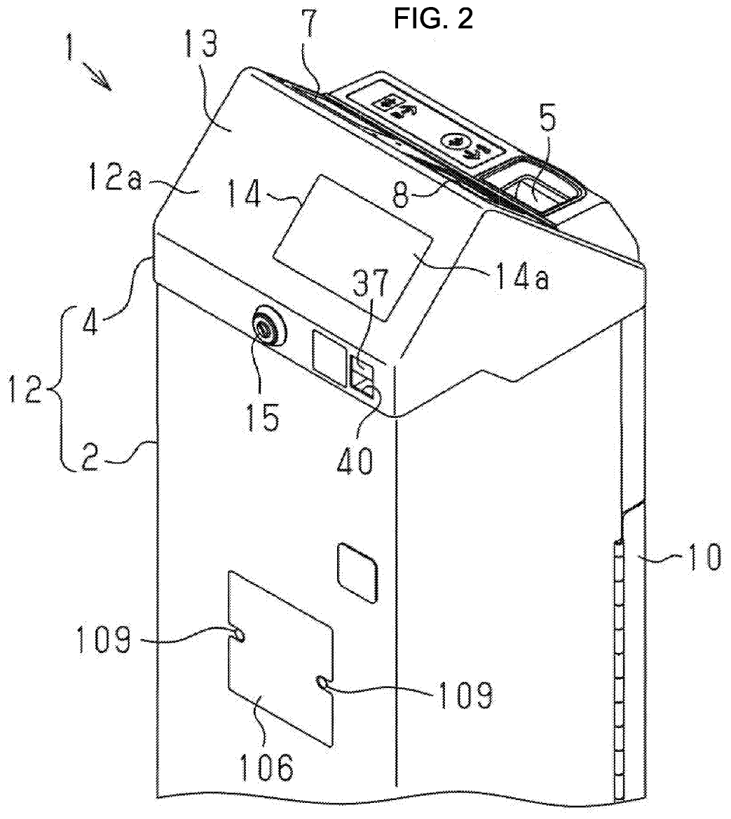

As shown in FIG. 2, a touch-panel-type operating part 14 which is operated at the time of setting an operation of reception and collection of money is mounted on a back surface of the fare box 1 (lid portion 4). An operation surface 14a of the touch-panel-type operating part 14 is formed on a surface 13 of a fare box housing 12. In this embodiment, the operation surface 14a of the touch-panel-type operating part 14 is disposed so as to be coplanar with the surface 13 of the fare box housing 12. Setting which can be changed by operating the touch-panel-type operating part 14 includes: a fare change of fares; counting of a student certificate; inputting of a defect, a wireless communication between communication equipment in a vehicle (a Wi-Fi rooter, for example) and the fare box 1, intercommunication with the information reading part 7 and the like. It is preferable that the touch-panel-type operating part 14 be a resistance-film-type touch panel, for example. The lid portion 4 is locked or unlocked by a lock 15 mounted on a back surface of the lid portion 4.

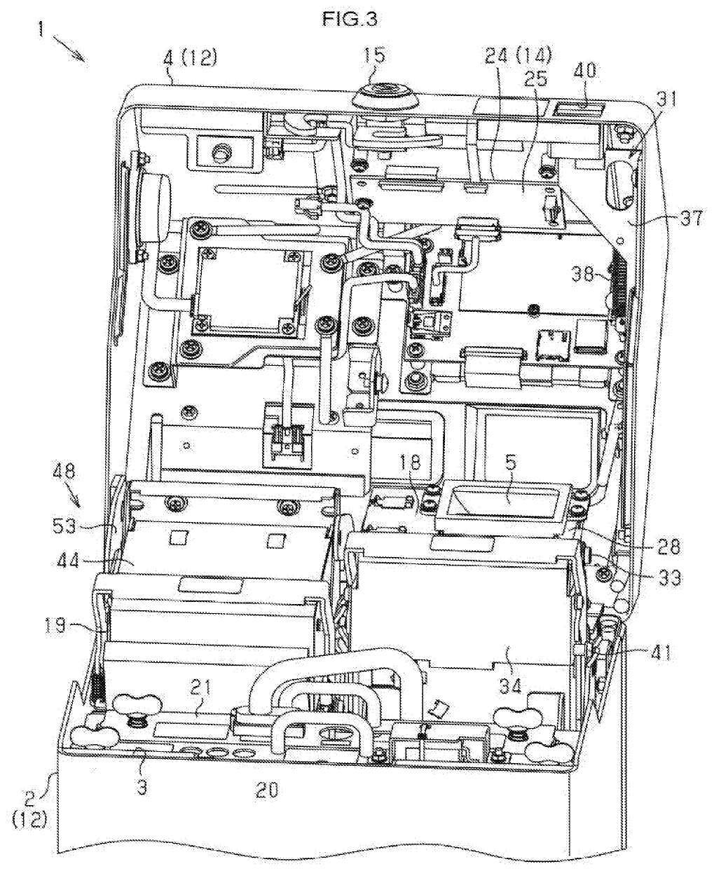

As shown in FIG. 3, in the inside of the fare box body 2, a coin identification module 18 which identifies coins received by the coin receiving port 5, a bill identification module 19 which identifies bills received by the bill receiving port 6, a control module 20 which controls an operation of the fare box 1, and a power source module 21 which controls a power source of the fare box 1. These modules are detachably mounted on the fare box body 2.

A panel control part 24 which controls an operation of the touch-panel-type operating part 14 is mounted on an inner wall surface of the lid portion 4. The panel control part 24 is formed of a unit where a controller such as a central processing unit (CPU), for example, is mounted on a printed circuit board 25. The panel control part 24 is disposed in the inside of the fare box housing 12. The printed circuit board 25 is fixed to an inner wall surface of the lid portion 4 by bolts or the like, and is electrically connected to other electric components (the information reading part 7, the display part 8, the control module 20 and the like) of the fare box 1 via various lines.

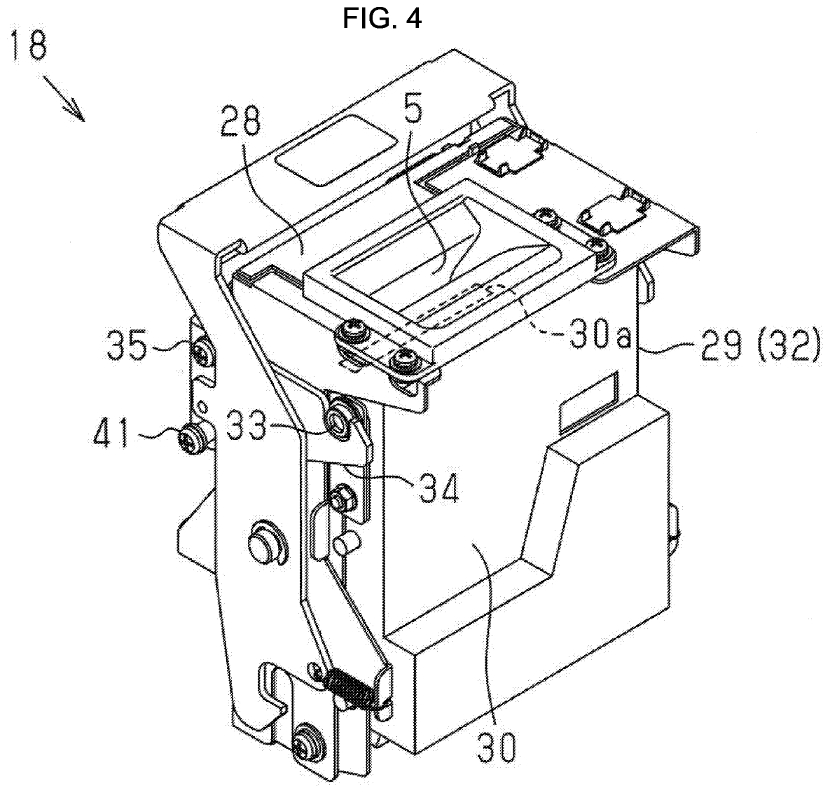

As shown in FIG. 4, the coin identification module 18 includes: a module body part 28; and a coin identification sensor part 29 which identifies a kind of a coin inputted from the coin receiving port 5 formed on an upper surface of the module body part 28. Coins are put in the coin receiving port 5 one by one. The coin identification sensor part 29 takes in coins which are put in the coin receiving port 5 through a hole portion 30a of a coin identifier 30, and allows the coins to drop downward while identifying the coins by the coin identifier 30.

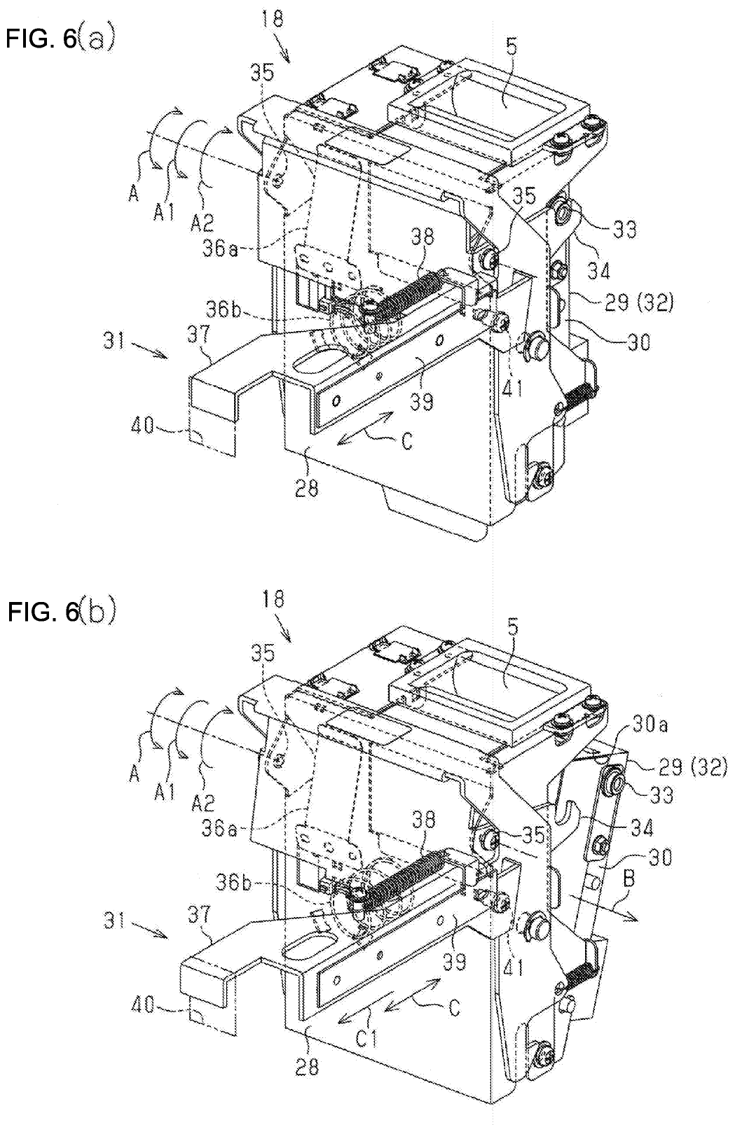

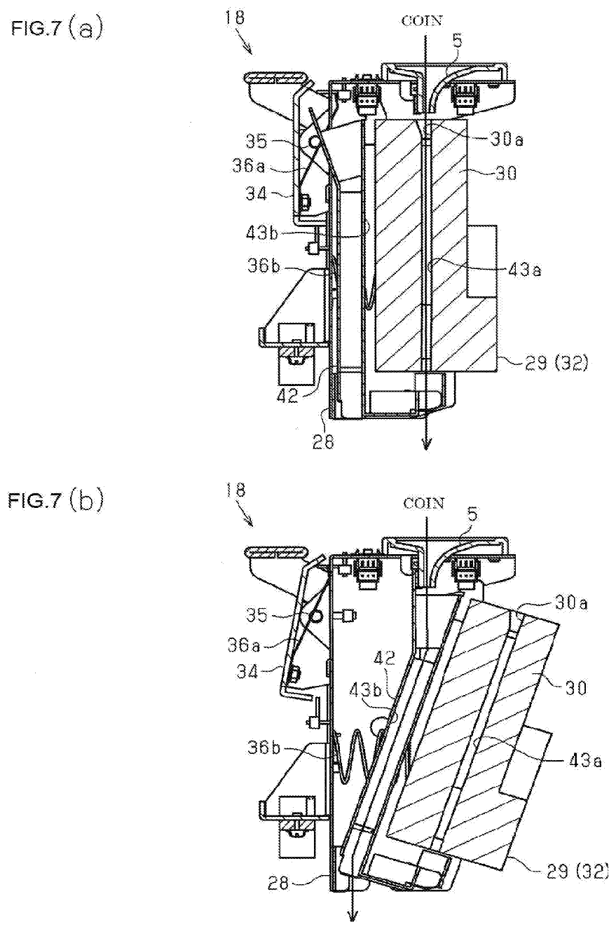

As shown in FIGS. 6A, 6B, 7A, and 7B, the fare box 1 includes a coin path switching mechanism 31 which switches a coin path in the coin identification module 18 to a bypass path 43b. For example, when the coin path is clogged by a foreign substance or the coin identifier 30 cannot read coins due to smear, a defect or the like, the coin path switching mechanism 31 switches the coin path from a normal path 43a through which coins pass at the time of identifying the coins to the bypass path 43b which does not allow the coins to pass through the coin identifier 30. In this embodiment, the coin path switching mechanism 31 operates a movable part 32 (coin identification sensor part 29 in this embodiment) positioned on the coin path of the coin identification module 18 when the lid portion 4 which opens or closes the opening portion 3 of the fare box body 2 is in a closed state thus switching the coin path to the bypass path 43b. Accordingly, the coins put in the fare box are forcibly discharged from the coin identification module 18.

As shown in FIGS. 6A and 6B, the coin path switching mechanism 31 switches the coin path by releasing the engagement between a pair of protrusions 33 formed on the coin identification sensor part 29 and movable engaging plates 34. The engaging plates 34 are connected to the module body part 28 such that the engaging plates 34 are rotatable about a pair of left and right shaft portions 35 (in an arrow A direction in FIGS. 6A and 6B). A biasing portion 36a which biases the engaging plates 34 in a locking direction (in an arrow A1 direction in FIGS. 6A and 6B) is disposed between the module body part 28 and the engaging plates 34. A biasing portion 36b which biases the coin identification sensor part 29 in an opening direction (in an arrow B direction in FIG. 6B) is disposed between the module body part 28 and the coin identification sensor part 29.

The coin path switching mechanism 31 includes a lever portion 37 which is operated at the time of releasing the engagement between the protrusions 33 and the engaging plates 34. The lever portion 37 is assembled to the lid portion 4 by way of a biasing portion 38 which returns the lever portion 37 to an initial operation position such that the lever portion 37 moves in a reciprocating manner on a straight line direction (an arrow C direction in FIGS. 6A and 6B). The biasing portion 38 is formed of a coil spring, and one end of the coil spring is mounted on the lever portion 37 and the other end of the coil spring is mounted on a plate member 39 on a lid portion 4 side. The lever portion 37 is assembled into the inside of the lid portion 4 and one end of the lever portion 37 is exposed to the outside from a hole portion 40 formed in the lid portion 4. When an operation of pulling the lever portion 37 (an operation in an arrow C1 direction in FIG. 6B) is performed, the other end of the lever portion 37 lifts protruding portions 41 of the engaging plates 34 and hence, the engaging plates 34 are rotated in an unlocking direction (an arrow A2 direction in FIGS. 6A and 6B).

As shown in FIGS. 7A and 7B, the coin identification sensor part 29 includes: the previously-mentioned coin identifier 30 which identifies kinds of coins; and a support plate 42 which supports the coin identifier 30 from a back surface side. The normal path 43a through which coins pass at the time of identification is formed in the coin identifier 30. The bypass path 43b is formed in the support plate 42. The bypass path 43b makes coins put in the fare box directly fall downward without allowing the coins put in the fare box to pass through the coin identifier 30.

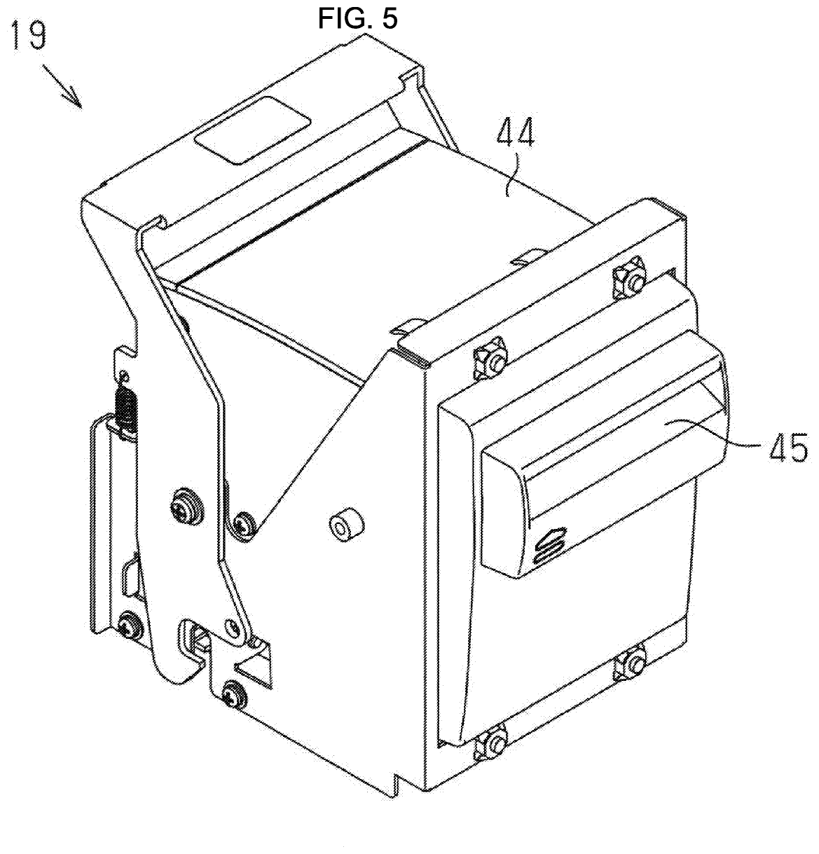

As shown in FIG. 5, the bill identification module 19 identifies kinds of bills inputted from an inlet 45 formed on a front surface of the module body portion 44 by a sensor (not shown in the drawing) disposed in the inside of the module body portion 44, and discharges the bills downward after identification. The bill identification module 19 according to this embodiment has only one path through which taken-in bill pass, and is not provided with a bypass path which forms a separate path for forcibly taking in bills into the bypass path when clogging of bills occurs.

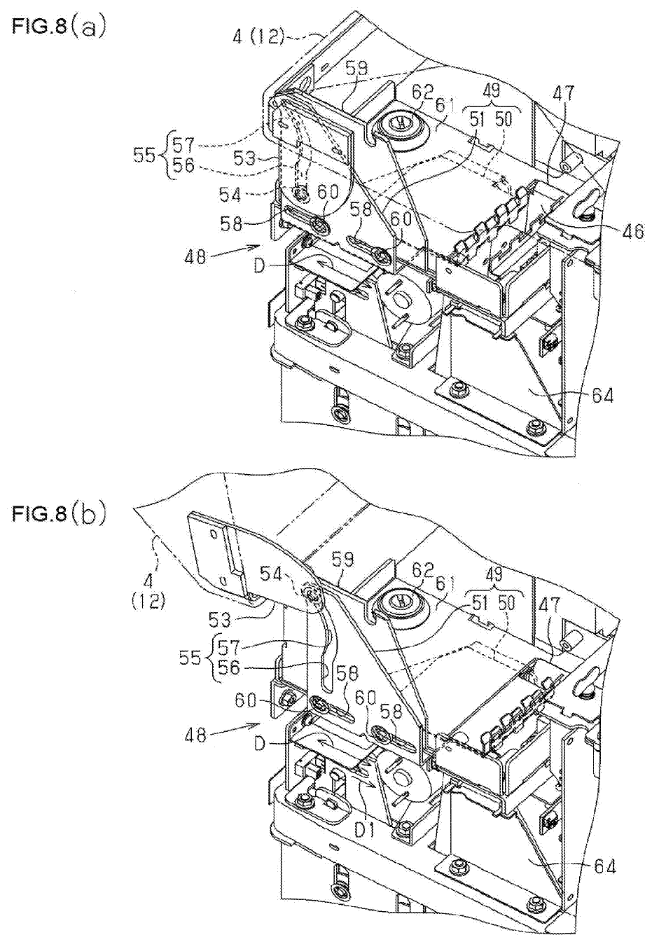

As shown in FIGS. 8A and 8B, the fare box 1 includes a bill path shutter mechanism 48 which closes a bill path 46 (a path formed by a bill chute 47 in this embodiment) in the fare box body 2 in an interlocking manner with an operation of opening the lid portion 4. In this embodiment, in the bill path shutter mechanism 48, a shutter portion 49 is disposed so as to move in a reciprocating manner in a straight line direction (an arrow D direction in FIGS. 8A and 8B). By slidably moving the shutter portion 49 in a closing direction (the arrow D1 direction in FIG. 8B) in an interlocking manner with an operation of opening the lid portion 4, the bill path 46 is brought into a closed state.

The shutter portion 49 includes: a first plate 50 which conceals the bill path 46; and a second plate 51 raised with respect to the first plate 50. A cam portion 53 which is provided so as to be operating in an interlocking manner with an opening or closing operation of the lid portion 4 is disposed at a position adjacently to the second plate 51 parallel to the second plate 51. A protruding portion 54 is formed on a side surface of the cam portion 53, and the protruding portion 54 is engaged with a guide groove 55 formed in the second plate 51. The guide groove 55 includes: a first groove portion 56 extending straightly in a direction orthogonal to a moving direction of the shutter portion 49; and a second groove portion 57 having a curved shape. A pair of guides 58 which extends in a straightly moving direction of the shutter portion 49 is formed on the second plate 51, and protrusions 60 of the plate member 59 of the fare box body 2 are inserted into these guides 58. When an opening or closing operation of the lid portion 4 is performed, the projecting portion 54 of the cam portion 53 moves in the guide groove 55 and pushes the shutter portion 49 so as to move the shutter portion 49 in a straight line direction (an arrow D direction in FIG. 8B) in a reciprocating manner.

The bill path shutter mechanism 48 includes a key equipped plate 61 which is mounted so as to conceal the shutter portion 49. The key equipped plate 61 can be removed from the fare box body 2 when the lock 62 is unlocked by an authentic key.

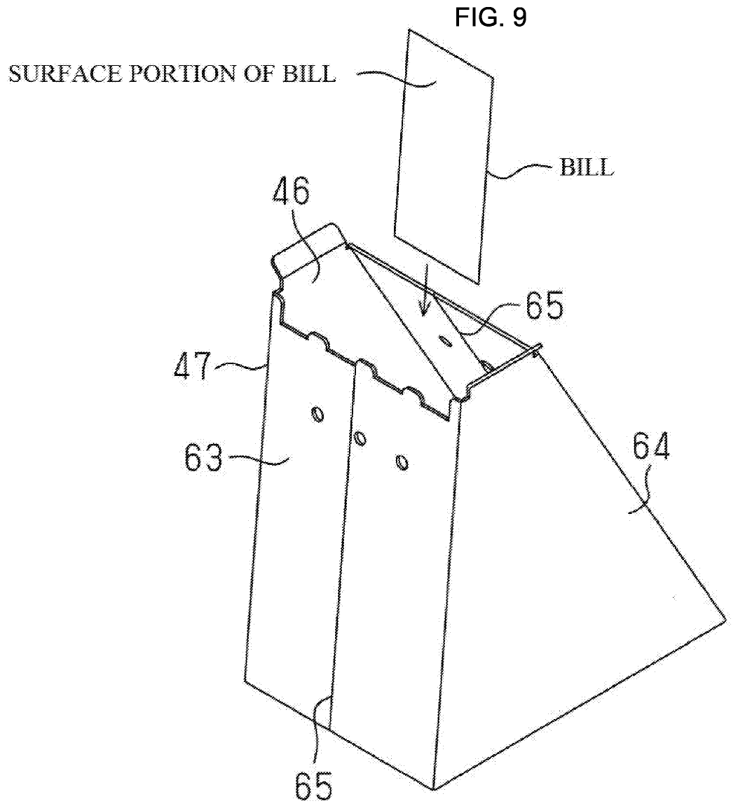

As shown in FIG. 9, the bill chute 47 is formed by assembling such that two chute members 63, 64 having an approximately U-shape cross section opposedly face each other. In this embodiment, the chute members 63, 64 are formed into the assembly structure where assembling seams 65 are directed so as to opposedly face surface portions of a bill.

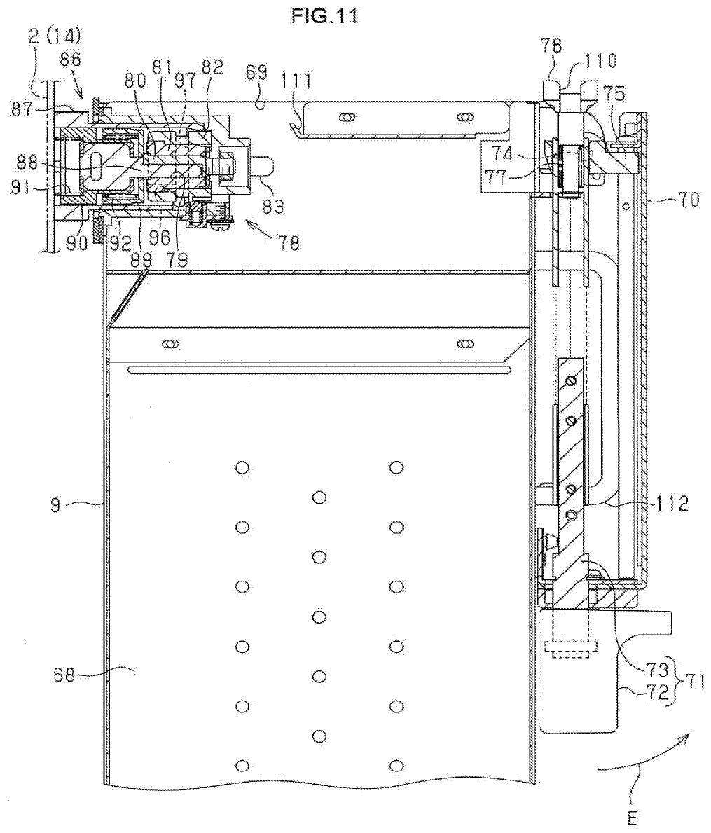

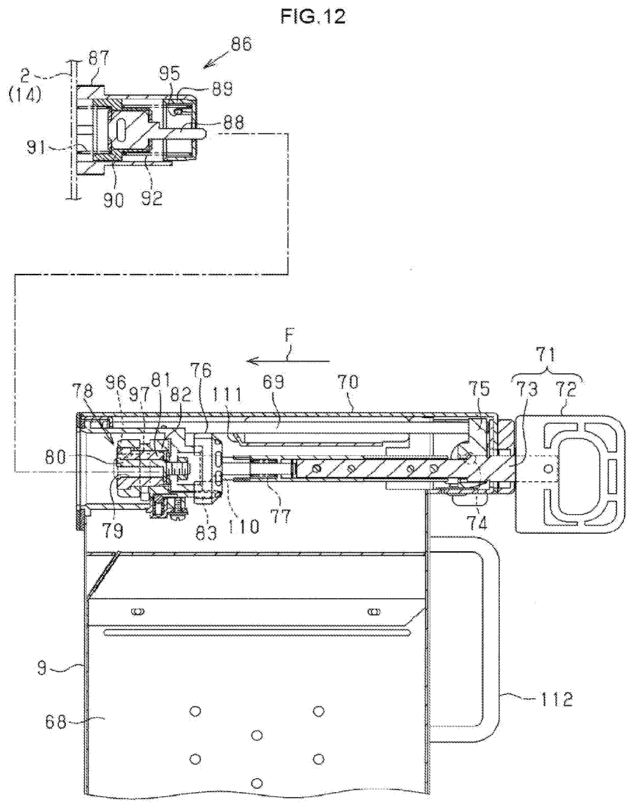

As shown in FIGS. 11 and 12, the safe 9 includes: a safe body 68 which stores coins and bills; and a safe lid 70 which opens or closes an upper opening 69 of the safe body 68. The safe lid 70 has a lid operating portion 71 which is operated at the time of mounting the safe 9 on the fare box body 2 and at the time of removing the safe 9 from the fare box body 2. The lid operating portion 71 has a handle 72, and a shaft portion 73 which is slidably operable and rotatably operable integrally with the handle 72. The shaft portion 73 adopts the two-shaft split structure such that a shaft length of the shaft portion 73 can be changed. The shaft portion 73 is inserted into a block 75 which is rotatable about a shaft 74 extending in a width direction of the safe 9 such that the shaft portion 73 is movable straightly in a reciprocating manner in an axial direction. A shaft engaging portion 76 which engages with the safe body 68 after the safe lid 70 is closed and the lid operating portion 71 is rotated is mounted on a distal end of the shaft portion 73. A biasing portion 77 which biases the shaft engaging portion 76 from a back surface side is mounted between the shaft portion 73 and the shaft engaging portion 76.

A lock portion 78 which locks or unlocks the safe lid 70 is mounted on the safe body 68. The lock portion 78 having the cylinder lock structure includes: an inner cylinder 80 having a key hole 79; an outer cylinder 81 which is fitted on the inner cylinder 80; and an operating sleeve 82 which is integrally rotatable with the outer cylinder 81. An arm portion 83 extending along an axial direction of the lock portion 78 is formed on the operating sleeve 82. When the safe lid 70 is operated so as to assume a closed state, the shaft engaging portion 76 is engaged with the arm portion 83 of the operating sleeve 82. Accordingly, integral rotation of the lid operating portion 71 and the operating sleeve 82 is allowed in a state where the safe lid 70 is in a closed state.

A key plate portion 86 which is inserted into the lock portion 78 of the safe 9 is formed on an inner wall surface of the fare box body 2. The key plate portion 86 includes a housing 87, a keep plate 88 which is inserted into the key hole 79 of the lock portion 78, and a cap 89 which closes an opening of the housing 87. A biasing portion 91 which biases the key plate 88 from a back surface side is disposed between a seat portion 90 of the key plate 88 and the inner wall surface of the fare box body 2. A biasing portion 92 which biases the cap 89 from a back surface side is disposed between the cap 89 and the seat portion 90.

A plurality of protrusions 95 (only one protrusion 95 shown in FIG. 12) are formed on an inner surface of the housing 87. These protrusions 95 are engageable with the operating sleeve 82 when the key plate portion 86 is inserted into the lock portion 78. A plurality of path grooves 96 are formed on an outer peripheral surface of the operating sleeve 82. These path grooves 96 allow the movement of the protrusions 95 when the key plate portion 86 is inserted into the lock portion 78. Engaging grooves 97 with which the protrusions 95 of the key plate portion 86 engage are formed on an outer peripheral surface of the operating sleeve 82 along a circumferential direction of the lock portion 78. When the safe 9 is mounted on the fare box body 2 and the safe lid 70 is brought into an open state (see a state shown in FIG. 11), the protrusions 95 are caught by the engaging grooves 97 of the operating sleeve 82 so that the illegal removal of the safe 9 from the fare box body 2 becomes impossible.

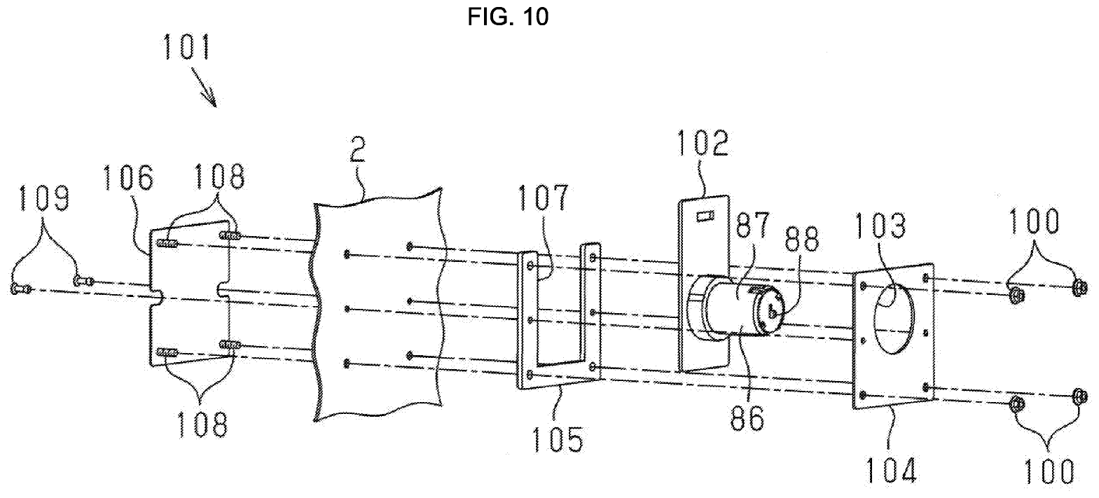

As shown in FIG. 10, the key plate portion 86 is mounted on and fixed to the fare box body 2 by the split assembly mechanism 101 where the key plate portion 86 is assembled to the fare box body 2 by threadedly mounting portions 100 by way of a plurality of plate members (plates). In this embodiment, the split assembly mechanism 101 includes: a support plate 102 on which the key plate portion 86 is mounted; a pressing plate 104 having a hole portion 103 through which the key plate portion 86 passes; an intermediate plate 105 disposed between a wall of the fare box body 2 and the pressing plate 104; and an outer frame plate 106 mounted on the fare box body 2 from the outside.

In this embodiment, the key plate portion 86 is fixed to the fare box body 2 in such a manner that the support plate 102 is fitted into a cut-off groove 107 formed on the intermediate plate 105, the support plate 102 is pressed by the pressing plate 104, and a plurality of fastening shafts 108 of the outer frame plate 106 are inserted into respective holes formed in the fare box body 2, the intermediate plate 105 and the pressing plate 104 and are fastened by threadedly engaging portions 100. These plate members (the fare box body 2, the pressing plate 104 and the intermediate plate 105 in this embodiment) are fixed by a plurality of (two in this embodiment) rivets 109.

As shown in FIG. 11, in removing the safe 9 from the fare box body 2, a user grasps the handle 72, lifts the lid operating portion 71 in an upward direction (in an arrow E direction in FIG. 11), and rotates the lid operating portion 71 about the shaft 74 by approximately 90 degrees. At this stage of operation, the lid operating portion 71 is rotated about the shaft 74 together with the block 75.

Subsequently, as shown in FIG. 12, the lid operating portion 71 which is lifted upward and is held horizontally is pushed into a depth side so as to slidably move the safe lid 70 and the lid operating portion 71 toward a depth side. At this stage of operation, the shaft portion 73 passes through the hole formed in the block 75 and hence, a slide operation of the safe lid 70 and the lid operating portion 71 toward a depth side (in an arrow F direction in FIG. 12) is allowed. When the shaft engaging portion 76 at a distal end of the shaft portion 73 reaches the lock portion 78, a groove portion 110 of the shaft engaging portion 76 engages with the arm portion 83 of the operating sleeve 82. Accordingly, the integral rotation of the lid operating portion 71 and the operating sleeve 82 is allowed.

After the safe lid 70 is closed, the handle 72 is rotated by approximately 90 degrees about the shaft portion 73 due to a rotary operation of the handle 72. At this stage of operation, the operating sleeve 82 is rotated together with the shaft engaging portion 76 in the same direction, and the path grooves 96 of the operating sleeve 82 and the protrusions 95 of the key plate portion 86 are aligned with each other so that the removal of the lock portion 78 from the key plate portion 86 is allowed. Further, a state is brought about where the shaft engaging portion 76 is aligned with a restricting plate 111 of the safe body 68 and hence, it becomes impossible to perform an operation of sliding the lid operating portion 71 toward an operator's side. That is, the safe lid 70 is locked to the safe body 68. Then, by shifting gripping to a gripping portion 112 on a side surface of the safe body 68 and by pulling out the safe 9, the safe 9 is taken out from the fare box body 2.

Next, the manner of operation and advantageous effects of the fare box 1 according to this embodiment are described with reference to FIGS. 2, 3, 6A to 8B and 10 to 12.

As shown in FIG. 2, in the fare box 1 of this embodiment, an operation system (operation panel) which an operator operates at the time of setting the fare box 1 is formed of the touch-panel-type operating part 14 which is integrally formed with the fare box 1 (lid portion 4). To consider a case where such an operation system is provided as a member separate from the fare box 1, an operation panel having a reasonable size is mounted on the fare box 1. In this case, the appearance of the fare box 1 is deteriorated, and it is also difficult to ensure operability of the operation panel. On the other hand, by assembling the operation system into the fare box 1 as in the case of this embodiment, the configuration of the fare box 1 can be simplified, and the operability is also enhanced.

Also in this embodiment, as shown in FIG. 3, the panel control part 24 on which the controller for controlling the touch-panel-type operating part 14 is mounted is assembled into the fare box 1. That is, a control system of the touch-panel-type operating part 14 is also integrally formed with the fare box 1. Accordingly, it is possible to position the operation system and the control system close to each other and hence, it is possible to make it difficult for a noise to superimpose on signals inputted or outputted between the operation system and the control system.

The panel control part 24 of the touch-panel-type operating part 14 is disposed in the inside of the fare box housing 12. Accordingly, it is possible to integrally arrange the control system of the touch-panel-type operating part 14 in the inside of the fare box housing 12. The operation surface 14a of the touch-panel-type operating part 14 is formed on the surface 13 of the fare box housing 12. Accordingly, the touch-panel-type operating part 14 can be disposed on the same plane as other surfaces of the fare box housing 12 (lid portion 4) and hence, operability of the touch-panel-type operating part 14 can be ensured.

As indicated by the flow from an operation in FIG. 6A to an operation in FIG. 6B, for example, when the coin path (the coin receiving port 5 or the hole portion 30a, for example) of the coin identification module 18 is clogged by a foreign substance (a coin or the like) or the coin identifier 30 cannot be used, the lever portion 37 is pulled toward an operator's side (in the arrow C1 direction in FIG. 6B). When the lever portion 37 is pulled toward the operator's side, the distal end of the lever portion 37 pulls and lifts the protruding portions 41 of the engaging plates 34 so that the engaging plates 34 are rotated in an unlocking direction (the arrow A2 direction in FIGS. 6A and 6B) about the shaft portion 35. Accordingly, the engagement between the protrusions 33 of the coin identification sensor part 29 and the engaging plates 34 is released, and the coin identification sensor part 29 is moved in an opening direction (the arrow B direction in FIG. 6B) due to a biasing force of the biasing portion 36b.

Accordingly, as shown in FIGS. 7A and 7B, after such an operation, coins put in the fare box 1 are effectively put in the inside of the bypass path 43b positioned on a back surface of the coin identifier 30 in place of the normal path 43a in the coin identifier 30. Accordingly, in a succeeding operation, coins put in the coin receiving port 5 are forcibly made to fall downward through the bypass path 43b positioned on the back surface of the coin identifier 30, and are stored in the safe 9 through the coin chute (not shown in the drawing) in the fare box body 2.

The coin identification sensor part 29 brought into an open state maintains its open state even when an operator leaves his hand from the lever portion 37. Accordingly, to return the coin identification sensor part 29 brought into an open state to an original closed state, it is necessary for an operator to open the lid portion 4 and to directly return the coin identification sensor part 29 to the closed state with his hand.

As indicated by the flow from an operation in FIG. 8A to an operation in FIG. 8B, when an operation of opening the lid portion 4 is performed, the lid portion 4 and the cam portion 53 are operated in an opening direction. At this stage of the operation, during a period in which the protruding portion 54 of the cam portion 53 moves in a straight-line-shaped first groove portion 56 of the guide groove 55, an operation of closing the shutter portion 49 is not yet performed and the shutter portion 49 maintains an open state. Then, when the protruding portion 54 starts to pass through a curved second groove portion 57 of the guide groove 55 along with the further rotation of the cam portion 53, the protruding portion 54 pushes the shutter portion 49 in a closing direction (in the arrow D1 direction in FIG. 8B) so that the shutter portion 49 starts the closing operation. Then, when the lid portion 4 is brought into a full open state, the shutter portion 49 is completely closed so that the bill path 46 (bill chute 47) is brought into a completely closed state. Accordingly, when the lid portion 4 is in an open state, a person cannot put his hand in the bill path 46 (bill chute 47) so that it is possible to ensure the crime prevention for a theft of bills.

Further, a key attached plate 61 which conceals the shutter portion 49 from above is disposed in the fare box body 2. Accordingly, a key for unlocking the lock 62 of the key attached plate 61 becomes necessary to remove the shutter portion 49 and hence, it is possible to ensure the crime prevention for an illegal removal of the shutter portion 49.

As shown in FIG. 10, as the structure of assembling the key plate portion 86 to the fare box body 2, the split assembly mechanism 101 is used where the key plate portion 86 is assembled to the fare box body 2 by threadedly engaging portions 100 by way of a plurality of plate members without using welding. Accordingly, for example, in a case where the key plate portion 86 is not normally operated, the key plate portion 86 can be simply replaced with a new key plate portion 86 and hence, the maintenance property of the key plate portion 86 can be also ensured. Particularly, in this embodiment, the pressing plate 104 is fixed to the fare box body 2 and the intermediate plate 105 by way of rivets 109. Accordingly, there is no possibility that the pressing plate 104 is illegally removed and hence, the structure provides a measure to prevent a theft of the key plate portion 86. It is also safe to say that the crime prevention property of the fare box 1 is high from this point of view.

As shown in FIGS. 11 and 12, the handle 72 which an operator operates at the time of opening or closing the safe lid 70 is provided as a part separate from the grip portion 112 which the operator holds with his hand at the time of carrying the safe body 68. With such a configuration, a size of the handle 72 can be made smaller compared to a usually available handle. Accordingly, in a case where the safe lid 70 is in a closed state, even when a person intends to illegally operate the handle 72 in an opening direction, he cannot apply a large force to the handle 72. Accordingly, it is possible to prevent an illegal operation of opening the safe lid 70. Further, out of the lid operating portion 71 and the lock portion 78, the lock portion 78 is fixed and the lid operating portion 71 is made movable by the biasing portion 77. Accordingly, the number of biasing portions (the number of springs) can be reduced.

The embodiment is not limited to the above-mentioned configuration, and may be changed to the following modes.

The touch-panel-type operating part 14 is not limited to the arrangement where the touch-panel-type operating part 14 is disposed on the same plane as the surface (panel mounting surface) of the lid portion 4. For example, the touch-panel-type operating part 14 may be disposed in a state where the touch-panel-type operating part 14 is inclined with respect to the surface (panel mounting surface) of the lid portion 4. In this case, a state is brought about where a screen of the touch-panel-type operating part 14 faces a driver and hence, operability of the touch-panel-type operating part 14 is enhanced.

The arrangement position of the touch-panel-type operating part 14 is suitably changeable to a center portion, a corner portion or the like of the panel mounting surface of the lid portion 4 (fare box 1), for example.

Buttons (switches) may be added to the touch-panel-type operating part 14, and a money receiving and collecting operation may be set by the buttons (switches).

The touch-panel-type operating part 14 is not limited to the structure which uses a resistance-film-type sensor, and may be configured to use other sensors.

The portion on which the touch-panel-type operating part 14 is disposed is not limited to the lid portion 4, and may be disposed at other portions such as a side wall of the fare box body 2, for example.

The movable part 32 of the coin path switching mechanism 31 is not limited to the coin identification sensor part 29, and may be changed to other member provided that the member is configured to have a coin path.

The coin identification sensor part 29 which assumes an open state due to an operation of the lever portion 37 may adopt the structure where the coin identification sensor part 29 automatically returns to an original closed state along with the release of an operation of the lever portion 37.

The coin path switching mechanism 31 can be suitably changed to structures other than the structure described in the embodiment.

The shutter portion 49 is not limited to a slidably movable member and may be a rotatable member, for example.

The bill path shutter mechanism 48 can be suitably changed to structures other than the structure described in the embodiment.

Next, the technical concepts grasped from the above-mentioned embodiment and other embodiments are additionally described hereinafter together with advantageous effects brought about by the technical concepts.

(a) A fare box for receiving and collecting money put in the fare box as a fare, wherein the fare box includes a bill path shutter mechanism which closes a bill path disposed in the inside of a fare box body in an interlocking manner with an operation of opening a lid portion which opens or closes an opening portion of the fare box body. In this type of fare box, the bill path is disposed in the inside of the fare box and hence, in a case where a door portion of the fare box is brought into an open state, a person can put his hand into the bill path. Accordingly, there is a concern that bills are stolen. However, in the case of the above-mentioned configuration, when an operation of opening the door portion is performed, the bill path is closed by the bill path shutter mechanism in an interlocking manner with such a door portion opening operation and hence, crime prevention can be ensured with respect to a theft of bills.

(b) A fare box for receiving and collecting money put in the fare box as a fare, wherein the fare box includes a coin path mechanism which switches a path through which coins pass to a bypass path where coins do not pass through a coin identifier of a coin identification sensor part. In this type of fare box, although kinds of coins can be identified by the coin identifier of the coin identification module, a possibility is not deniable that a coin path in the coin identifier is clogged by a coin or the coin identifier cannot read a coin due to smear, defect or the like. Accordingly, in the case of the above-mentioned configuration, when a situation is brought about where a coin cannot be identified by the coin identifier as described above, the coin can be forcibly discharged by switching a path through which the coin passes to the bypass path provided as a separate path and hence, even when an abnormality occurs in the coin identifier, the fare box can receive and collect the coins without stagnation.

### DESCRIPTION OF REFERENCE SIGNS

1: fare box
2: fare box body
3: opening portion
4: lid portion
12: fare box housing
13: surface
14: touch-panel-type operating part
14a: operation surface
18: coin identification module
29: coin identification sensor part
30: coin identifier
31: coin path switching mechanism
32: movable part
43a: normal path
43b: bypass path
46: bill path
48: bill path shutter mechanism

1. A fare box which is configured to receive and collect money put in the fare box as a fare, wherein a touch-panel-type operating part which is operated at a time of setting an operation of receiving and collecting the money is integrally formed with the fare box, and wherein a panel control part which controls an operation of the touch-panel-type operating part is disposed in an inside of a fare box housing, and an operation surface of the touch-panel-type operating part is formed on a surface of the fare box housing.

2. (canceled)

3. The fare box according to claim 1, comprising a bill path shutter mechanism which closes a bill path formed in an inside of a fare box body in an interlocking manner with an operation of opening a lid portion which opens or closes an opening portion of the fare box body.

4. The fare box according to claim 1, comprising a coin path mechanism which, in a state where the lid portion which opens or closes the opening portion of the fare box body is in a closed state, switches a path through which a coin passes to a bypass path where coins do not pass through a coin identifier of a coin identifying sensor part by operating a movable part positioned on a coin path of a coin identification module.
